(19) United States
(12) Patent Application Publication
(10) Pub. No.: US 2026/0179646 A1
(43) Pub. Date: Jun. 25, 2026

(54) VOICE DETECTION METHOD AND APPARATUS, ELECTRONIC DEVICE AND STORAGE MEDIUM

(71) Applicant: Beijing Youzhuju Network Technology Co., Ltd., Beijing (CN)

(72) Inventors: Shixue WEN, Beijing (CN); Zejun MA, Beijing (CN)

(21) Appl. No.: 19/128,901

(22) PCT Filed: Nov. 8, 2023
(86) PCT No.: PCT/CN2023/130471

§ 371 Date: May 9, 2025

(30) Foreign Application Priority Data
Nov. 9, 2022 (CN) 202211399252.7

(51) Int. Cl. G10L 25/78

(52) U.S. Cl. CPC G10L 25/78

(57) ABSTRACT

The present application provides a voice detection method and apparatus, an electronic device and a storage medium. The method comprises: acquiring a multi-channel signal, the multi-channel signal carrying a current signal type; inputting the multi-channel signal into a joint model to obtain a voice detection result corresponding to the signal type, the joint model comprising a first model and a second model, the first model being used to process the multi-channel signal into a single-channel signal, and the second model being used to process the single-channel signal into a voice detection result.

### CROSS REFERENCE TO RELATED APPLICATIONS

This application is based on and claims priority from Chinese Patent Application Number 202211399252.7, filed on Nov. 9, 2022, the disclosure of which is incorporated herein by reference in its entirety.

### TECHNICAL FIELD

This application relates to a speech detection method and apparatus, an electronic device, and a storage medium.

### BACKGROUND

Voice activity detection (voice activity detection, VAD) is used for detecting a speech in an audio segment.

Current mainstream VADs are usually based on single-channel audio, that is, most mainstream VAD methods only use an audio signal of a single microphone and then perform speech detection based on the single-channel audio signal.

### SUMMARY

According to an aspect of the embodiments of this application, a speech detection method is provided, and the method includes:
obtaining a multi-channel signal, where the multi-channel signal carries a current signal type (S201); and
inputting the multi-channel signal into a joint model to obtain a speech detection result corresponding to the signal type, where the joint model includes a first model and a second model, the first model is configured to process the multi-channel signal into a single-channel signal, and the second model is configured to process the single-channel signal into the speech detection result (S202).

According to another aspect of the embodiments of this application, a speech detection apparatus is further provided, and the apparatus includes:
an acquisition module configured to obtain a multi-channel signal, where the multi-channel signal carries a current signal type; and
a first obtaining module configured to input the multi-channel signal into a joint model to obtain a speech detection result corresponding to the signal type, where the joint model includes a first model and a second model, the first model is configured to process the multi-channel signal into a single-channel signal, and the second model is configured to process the single-channel signal into the speech detection result.

According to yet another aspect of the embodiments of this application, an electronic device is further provided, and the electronic device includes a processor, a communication interface, a memory and a communication bus, where the processor, the communication interface and the memory achieve mutual communication through the communication bus, the memory is configured to store a computer program, and the processor is configured to execute the method steps in any one of the above embodiments by running the computer program stored in the memory.

According to yet another aspect of the embodiments of this application, a computer-readable storage medium is further provided, where the computer-readable storage medium stores a computer program, and the computer program is configured to execute the method steps in any one of the above embodiments when running.

According to yet another aspect of the embodiments of this application, a computer program is further provided, and the computer program includes instructions, where the instructions, when executed by a processor, cause the processor to execute the method steps in any one of the above embodiments.

According to yet another aspect of the embodiments of this application, a computer program product is further provided, and the computer program product includes instructions, where the instructions, when executed by a processor, cause the processor to execute the method steps in any one of the above embodiments.

### BRIEF DESCRIPTION OF THE DRAWINGS

The drawings herein are incorporated into and constitute a part of the specification, illustrate the embodiments consistent with the application, and together with the specification, serve to explain the principles of the application.

In order to more clearly illustrate the technical solutions in the embodiments of the present application or in the related art, the following will briefly introduce the drawings that need to be used in the description of the embodiments or the related art. Obviously, for those of ordinary skill in the art, other drawings can be obtained based on these drawings without any creative effort.

FIG. 1 is a schematic diagram of a hardware environment of an optional speech detection method according to embodiments of the present application;

FIG. 2 is a schematic flowchart of an optional speech detection method according to embodiments of the present application;

FIG. 3 is a structural block diagram of an optional speech detection apparatus according to embodiments of the present application; and FIG. 4 is a structural block diagram of an optional electronic device according to embodiments of the present application.

### DETAILED DESCRIPTION

In order to make those skilled in the art better understand the solutions of this application, the technical solutions in the embodiments of this application will be clearly and completely described below with reference to the drawings in the embodiments of this application. Apparently, the described embodiments are merely some rather than all of the embodiments of this application. All other embodiments obtained by persons of ordinary skill in the art based on the embodiments of this application without creative efforts shall fall within the protection scope of this application.

It should be noted that the terms “first”, “second” and the like in the specification, claims and drawings of this application are intended to distinguish between similar objects, but not necessarily to describe a particular order or sequence. It should be understood that the data so used may be interchanged in appropriate circumstances so that the embodiments of this application described herein may be implemented in a sequence other than those illustrated or described herein. In addition, the terms “include” and “have” and any variations thereof are intended to cover non-exclusive inclusion. For example, a process, method, system, product, or device that includes a series of steps or units is not necessarily limited to those steps or units that are clearly listed, but may include other steps or units that are not clearly listed or are inherent to these processes, methods, products, or devices.

In real life, a device may be equipped with a plurality of microphone channels. At this time, only using a single-channel VAD detection method in a far-field speech interaction scenario will make it difficult to successfully detect a speech with minimum energy, resulting in low sensitivity and high missed detection rate and false detection rate in noisy environments. According to an aspect of the embodiments of this application, a speech detection method is provided. Optionally, in this embodiment, the above speech detection method may be applied to a hardware environment as shown in FIG. 1. As shown in FIG. 1, the terminal 102 may include a memory 104, a processor 106 and a display 108 (an optional component). The terminal 102 may be in communication connection with a server 112 through a network 110, and the server 112 may be configured to provide a service for the terminal or a client installed on the terminal. A database 114 may be provided on the server 112 or independently of the server 112 for providing a data storage service for the server 112. In addition, a processing engine 116 may be run on the server 112, and the processing engine 116 may be configured to execute the steps performed by the server 112.

Optionally, the terminal 102 may be, but not limited to, a terminal that can compute data, such as a mobile terminal (e.g., a mobile phone, a tablet computer), a laptop computer, a PC (Personal Computer, personal computer), etc. The above network may include, but not limited to, a wireless network or a wired network. The wireless network includes Bluetooth, WIFI (Wireless Fidelity, wireless fidelity) and other networks that can implement wireless communication. The wired network may include, but not limited to, a wide area network, a metropolitan area network, and a local area network. The above server 112 may include, but not limited to, any hardware device that can perform computing.

In addition, in this embodiment, the above speech detection method may also be applied to, but not limited to, an independent processing device with a powerful processing capability without performing data interaction. For example, the processing device may be, but not limited to, a terminal device with a powerful processing capability, that is, operations in the above speech detection method may be integrated into an independent processing device. The above is only an example, and no limitation is made in this embodiment.

Optionally, in this embodiment, the above speech detection method may be executed by the server 112, or may be executed by the terminal 102, or may be executed by the server 112 and the terminal 102 together. The method for speech detection performed by the terminal 102 may also be performed by a client installed on the terminal 102.

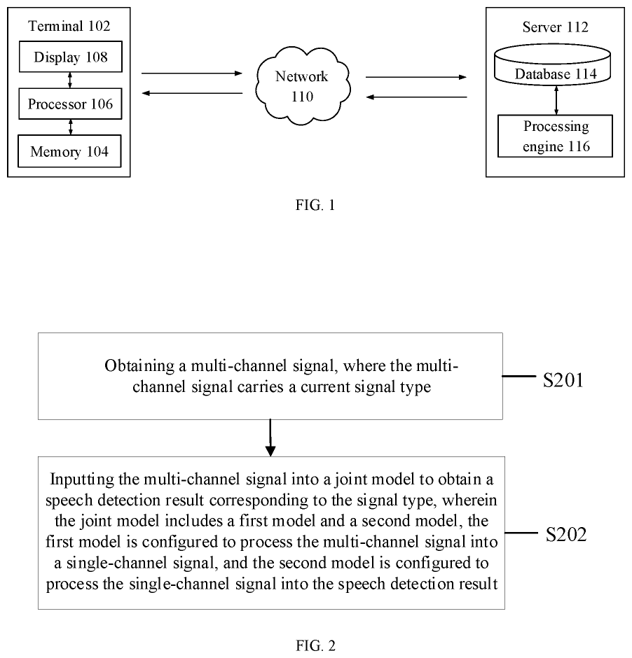

Taking running on a microphone device server as an example, FIG. 2 is a schematic flowchart of an optional speech detection method according to embodiments of the present application. As shown in FIG. 2, the process of the method may include the following steps:
Step S201: obtaining a multi-channel signal, where the multi-channel signal carries a current signal type; and
Step S202: inputting the multi-channel signal into a joint model to obtain a speech detection result corresponding to the signal type, where the joint model includes a first model and a second model, the first model is configured to process the multi-channel signal into a single-channel signal, and the second model is configured to process the single-channel signal into the speech detection result.

Optionally, in this embodiment of this application, a microphone array may be used to collect a multi-channel signal. The multi-channel signal collected by the microphone array may include a current signal type, such as an audio type or a feature type. Then, the multi-channel signal is input into a trained joint model, and the joint model outputs a speech detection result corresponding to the signal type.

It should be noted that the joint model herein includes the first model and the second model, the first model is configured to process the multi-channel signal into the single-channel signal, and the second model is configured to process the single-channel signal into the speech detection result. In this way, the current speech detection result can be obtained by means of the joint model. The first model may be a beam model, which is mainly configured to process the multi-channel signal into the single-channel signal, and the second model may be a VAD model, which is mainly configured to process the single-channel signal to obtain the speech detection result. It should be noted that the first model includes but is not limited to a beam model, and similarly, the second model includes but is not limited to a VAD model.

In the embodiments of this application, the multi-channel signal is obtained in the manner of processing the multi-channel signal, where the multi-channel signal carries the current signal type; and the multi-channel signal is input into the joint model to obtain the speech detection result corresponding to the signal type, where the joint model includes the first model and the second model, the first model is configured to process the multi-channel signal into the single-channel signal, and the second model is configured to process the single-channel signal into the speech detection result. In the embodiments of this application, the multi-channel signal is obtained, and the multi-channel signal is input into the joint model including the first model and the second model for signal processing. In this way, the obtained speech detection result will have higher accuracy than single-channel audio detection in the related art, so that a speech with a minimum energy can be better detected, and a successful detection rate is increased in a noisy environment. Thus, the purpose of achieving lower missed detection rate and false detection rate can be realized, thereby solving the problems in the related art that it is difficult to successfully detect a speech with a minimum energy, the sensitivity is low, and the missed detection rate and the false detection rate are high in a noisy environment.

As an optional embodiment, before the inputting the multi-channel signal into the joint model, the method further includes:
obtaining a signal influence indicator according to the multi-channel signal, where the signal influence indicator is configured to affect a final output of the speech detection result; and
inputting the signal influence indicator and the multi-channel signal as input information into the joint model.

Optionally, after the microphone array obtains the multi-channel signal, the signal influence indicator may be calculated by some methods utilizing the microphone array. The signal influence indicator may be a signal score, and further, may be a signal-to-interference ratio. Then, feature fusion is performed on the signal influence indicator and the multi-channel signal, and then the fused feature is input into the joint model as an input signal.

It can be seen that since the signal influence indicator is also taken as the input information in the embodiment of this application, it will affect the final output of the speech detection result together with the multi-channel signal.

In the embodiments of this application, the obtained signal influence indicator is taken as part of the input information, so that the parameter of the signal influence indicator will be considered when outputting the speech detection result, thereby making the output result of speech detection more accurate.

As an optional embodiment, the inputting the multi-channel signal into the joint model to obtain the speech detection result corresponding to the signal type includes:
inputting the multi-channel signal into the first model;
processing, by the first model, the multi-channel signal to obtain the single-channel signal;
inputting the single-channel signal into the second model; and
processing, by the second model, the single-channel signal to obtain the speech detection result.

Optionally, before the multi-channel signal is input into the first model, the first model needs to be trained. At this time, a first training dataset may be obtained, where all training data in the first training dataset carries an identifier belonging to a plurality of target labels. A process of training the first model is as follows:
assuming that there are two target labels at present and the first training dataset is also divided into two parts, inputting a part of the training data with a first target label into a first initial model, and in combination with a loss function, obtaining a first probability value belonging to the first target label; inputting the other part of the training data with a second target label into the first initial model, and in combination with the loss function, obtaining a second probability value belonging to the second target label; stopping adjusting a model parameter of the first initial model if the first probability value and the second probability value are both less than or equal to a set first preset threshold, to obtain the first model; otherwise, adjusting the model parameter of the first initial model until the first probability value and the second probability value are both less than or equal to the set first preset threshold.

After the first model is trained, the multi-channel signal is input into the first model, and the first model processes the multi-channel signal to obtain the single-channel signal.

After that, the single-channel signal needs to be input into the second model. At this time, before the single-channel signal is input into the second model, the second model needs to be trained. A process of training the second model may use a traditional binary classification training, such as: obtaining a second training dataset, where all training data in the second training dataset carries an identifier belonging to a third target label, and the third model label may be 0 or 1; inputting all training data in the second training dataset into a second initial model, and in combination with a loss function, obtaining a third probability value belonging to the third target label; comparing the third probability value with a preset second preset threshold, and outputting a binary classification target result; comparing the target result with the third target label; stopping adjusting a model parameter of the second initial model in a case where the target result is consistent with the third target label, to obtain the second model, and otherwise, adjusting the model parameter of the second initial model until the output target result is consistent with the third target label.

After the second model is trained, the single-channel signal is input into the second model, and the second model processes the single-channel signal to obtain the speech detection result.

In the embodiments of this application, the first model and the second model are jointly optimized and trained, so that the models converge more easily, the performance is better, the obtained speech detection result is more accurate, and the missed detection rate and the false detection rate can be reduced.

As an optional embodiment, the signal type includes an audio, and the inputting the multi-channel signal into the joint model to obtain the speech detection result corresponding to the signal type includes:
inputting the multi-channel signal into the joint model in a case where the signal type is the audio; and
outputting the speech detection result at intervals of a preset number of audio sampling points.

Optionally, if the signal type of the multi-channel signal is the audio, that is, the input is time domain audio, the multi-channel signal is input into the joint model. At this time, the joint model outputs the speech detection result at intervals of a preset number of audio sampling points, such as every two audio sampling points.

As an optional embodiment, the signal type includes a feature, and the inputting the multi-channel signal into the joint model to obtain the speech detection result corresponding to the signal type includes:
inputting the multi-channel signal into the joint model and performing feature extraction and feature transformation on the multi-channel signal to obtain a frame frequency feature in a case where the signal type is the feature; and
outputting the speech detection result at intervals of a preset number of the frame frequency features.

Optionally, if the signal type of the multi-channel signal is the feature, that is, the input is a frequency domain feature, the multi-channel signal is input into the joint model. At this time, the joint model outputs the speech detection result at intervals of a preset number of frame frequency features, such as every two frames.

As an optional embodiment, after the inputting the multi-channel signal into the first model, the method further includes:
determining, by means of the first model, spatial information when the multi-channel signal is input; and
re-obtaining the multi-channel signal in a case where it is determined that the spatial information changes within a preset time period.

Optionally, after the microphone array obtains the multi-channel signal, the multi-channel signal is input into the first model, and then the spatial information when the multi-channel signal is input is determined by means of the first model, such as an azimuth angle and a pitch angle of a current speech audio. At this time, if it is found that the spatial information has changed greatly within a preset time period (usually a short time), it means that an audio may be currently emitted from another orientation, and at this time, acquisition of the multi-channel signal needs to be briefly stopped and the multi-channel signal needs to be re-obtained, so as to start a new speech activity detection. For example, the spatial information has changed greatly within the preset time period may be that the spatial information has changed in an angle within one second, such as the azimuth angle has changed from 90 degrees to 270 degrees.

In the embodiments of this application, the spatial information is combined into the speech detection, so that it can be adapted to more speech detection scenarios, and a scope of application of the technical solutions of this application is expanded.

As an optional embodiment, the determining, by means of the first model, the spatial information when the multi-channel signal is input includes:
determining, by means of the first model, an incidence orientation of the multi-channel signal; and
determining orientation information of a target object according to the incidence orientation, and taking the orientation information as the spatial information when the multi-channel signal is input.

Optionally, if a current scenario where the microphone array collects the multi-channel signal is a conversation scenario, the incidence orientation of the multi-channel signal may be detected by means of the first model, and then orientation information of a speaker (that is, a target object) is obtained according to the incidence orientation. Then, the orientation information of the target object corresponds to the spatial information when the multi-channel signal is input.

For example, when the azimuth angle has changed from 90 degrees to 270 degrees, it can be determined that although someone is still speaking at this time, it is not the same person probably, that is, the person has been changed. At this time, the multi-channel signal may be re-obtained for speech detection.

It should be noted that, for the above method embodiments, for the purpose of brief description, they are all expressed as a series of action combinations, but those skilled in the art should know that this application is not limited by the described action order, because according to this application, some steps may be performed in other orders or simultaneously. Secondly, those skilled in the art should also know that the embodiments described in the specification are all preferred embodiments, and the actions and modules involved are not necessarily required in this application.

Through the above description of the implementation manners, those skilled in the art can clearly know that the method according to the above embodiments may be implemented by means of software plus a necessary general hardware platform, and may also be implemented by hardware. In many cases, the former is a better implementation manner. Based on such understanding, the technical solutions of this application, in essence, or the part that contributes to the related art may be embodied in the form of a software product, where the computer software product is stored in a storage medium (such as ROM (Read-Only Memory, read-only memory)/RAM (Random Access Memory, random access memory), magnetic disk, optical disc), and includes several instructions to enable a terminal device (which may be a mobile phone, a computer, a server, or a network device, etc.) to perform the method of each embodiment of this application.

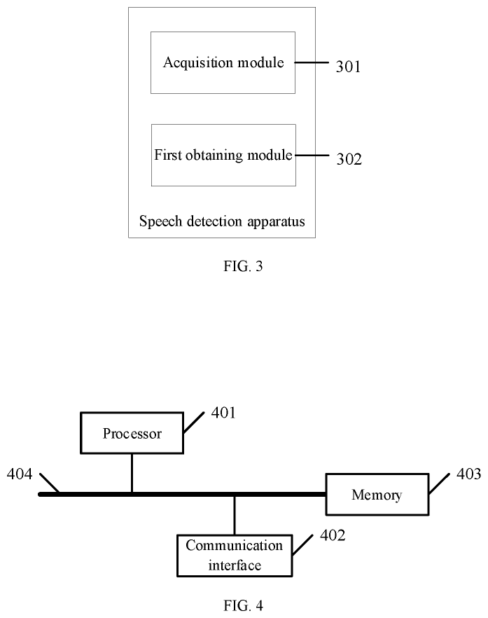

According to another aspect of the embodiments of this application, a speech detection apparatus for implementing the above speech detection method is further provided. FIG. 3 is a structural block diagram of an optional speech detection apparatus according to embodiments of this application. As shown in FIG. 3, the apparatus may include:
an acquisition module 301 configured to obtain a multi-channel signal, where the multi-channel signal carries a current signal type; and
a first obtaining module 302 configured to input the multi-channel signal into a joint model to obtain a speech detection result corresponding to the signal type, where the joint model includes a first model and a second model, the first model is configured to process the multi-channel signal into a single-channel signal, and the second model is configured to process the single-channel signal into the speech detection result.

It should be noted that the acquisition module 301 in this embodiment may be configured to execute the above step S101, and the first obtaining module 302 in this embodiment may be configured to execute the above step S102.

With the above modules, a multi-channel signal is obtained, and the multi-channel signal is input into a joint model including a first model and a second model for signal processing. In this way, the obtained speech detection result will have higher accuracy than single-channel audio detection in the related art, so that a speech with a minimum energy can be better detected, and a successful detection rate is increased in a noisy environment. Thus, the purpose of achieving lower missed detection rate and false detection rate can be realized, thereby solving the problems in the related art that it is difficult to successfully detect a speech with a minimum energy, the sensitivity is low, and the missed detection rate and the false detection rate are high in a noisy environment.

As an optional embodiment, the apparatus further includes:
a second obtaining module configured to obtain a signal influence indicator according to the multi-channel signal before the multi-channel signal is input into the joint model, where the signal influence indicator is configured to affect a final output of the speech detection result; and
an input module configured to input the signal influence indicator and the multi-channel signal as input information into the joint model.

As an optional embodiment, the first obtaining module includes:
a first input unit configured to input the multi-channel signal into the first model;
a first obtaining unit configured to process, by the first model, the multi-channel signal to obtain the single-channel signal;
a second input unit configured to input the single-channel signal into the second model; and
a second obtaining unit configured to process, by the second model, the single-channel signal to obtain the speech detection result.

As an optional embodiment, the signal type includes an audio, and the first obtaining module includes:
a third input unit configured to input the multi-channel signal into the joint model in a case where the signal type is the audio; and
a first output unit configured to output the speech detection result at intervals of a preset number of audio sampling points.

As an optional embodiment, the signal type includes a feature, and the first obtaining module includes:
a processing unit configured to input the multi-channel signal into the joint model and perform feature extraction and feature transformation on the multi-channel signal to obtain a frame frequency feature in a case where the signal type is the feature; and
a second output unit configured to output the speech detection result at intervals of a preset number of the frame frequency features.

As an optional embodiment, the apparatus further includes:
a determination module configured to determine, by means of the first model, spatial information when the multi-channel signal is input after the multi-channel signal is input into the first model; and
a collecting module configured to re-obtain the multi-channel signal in a case where it is determined that the spatial information changes within a preset time period.

As an optional embodiment, the determination module includes:
a determination unit configured to determine, by means of the first model, an incidence orientation of the multi-channel signal; and
a setting unit configured to determine orientation information of a target object according to the incidence orientation, and take the orientation information as the spatial information when the multi-channel signal is input.

It should be noted that the examples and application scenarios implemented by the above modules and corresponding steps are the same, but are not limited to the content disclosed in the above embodiments. It should be noted that the above modules, as part of the apparatus, may run in the hardware environment as shown in FIG. 1, and may be implemented by software or hardware, where the hardware environment includes a network environment.

According to yet another aspect of the embodiments of this application, an electronic device for implementing the above speech detection method is further provided, and the electronic device may be a server, a terminal, or a combination thereof.

FIG. 4 is a structural block diagram of an optional electronic device according to embodiments of the present application. As shown in FIG. 4, the electronic device includes a processor 401, a communication interface 402, a memory 403 and a communication bus 404. The processor 401, the communication interface 402 and the memory 403 achieve mutual communication through the communication bus 404.

The memory 403 is configured to store a computer program; and The processor 401 is configured to execute the following steps when executing the computer program stored in the memory 403:
obtaining a multi-channel signal, where the multi-channel signal carries a current signal type; and
inputting the multi-channel signal into a joint model to obtain a speech detection result corresponding to the signal type, where the joint model includes a first model and a second model, the first model is configured to process the multi-channel signal into a single-channel signal, and the second model is configured to process the single-channel signal into the speech detection result.

Optionally, in this embodiment, the above communication bus may be a PCI (Peripheral Component Interconnect, Peripheral Component Interconnect) bus, or an EISA (Extended Industry Standard Architecture, Extended Industry Standard Architecture) bus, etc. The communication bus may be divided into an address bus, a data bus, a control bus, etc. For ease of representation, FIG. 4 is shown with only one thick line, but it does not mean that there is only one bus or one type of bus.

The communication interface is configured for communication between the above electronic device and other devices.

The memory may include a RAM, and may also include a non-volatile memory (non-volatile memory), for example, at least one magnetic disk memory. Optionally, the memory may also be at least one storage apparatus located away from the above processor.

As an example, as shown in FIG. 4, the above memory 403 may include, but not limited to, the acquisition module 301 and the first obtaining module 302 in the above speech detection apparatus. In addition, other module units in the above speech detection apparatus may also be included, but not limited to, which will not be repeated in this example.

The above processor may be a general-purpose processor, which may include but not limited to: a CPU (Central Processing Unit, central processing unit), an NP (Network Processor, network processor), etc. ; and may also be a DSP (Digital Signal Processing, digital signal processor), an ASIC (Application Specific Integrated Circuit, application-specific integrated circuit), an FPGA (Field-Programmable Gate Array, field-programmable gate array) or other programmable logic devices, discrete gate or transistor logic devices, and discrete hardware components.

In addition, the above electronic device further includes a display configured to display the speech detection result.

Optionally, for a specific example in this embodiment, reference may be made to the examples described in the above embodiments, and details are not described herein again in this embodiment.

Persons of ordinary skill in the art may understand that the structure shown in FIG. 4 is only schematic, and a device for implementing the above speech detection method may be a terminal device. The terminal device may be a smartphone (such as an Android phone, an iOS phone, etc.), a tablet computer, a handheld computer, a mobile Internet device (Mobile Internet Devices, MID), a PAD, and other terminal devices. FIG. 4 does not limit the structure of the above electronic device. For example, the terminal device may include more or fewer components (such as a network interface, a display device, etc.) than those shown in FIG. 4, or may have a different configuration from that shown in FIG. 4.

Persons of ordinary skill in the art may understand that all or part of steps in various methods of the above embodiments may be achieved by instructing hardware related to a terminal device through a program, where the program may be stored in a computer-readable storage medium, and the storage medium may include a flash disk, a ROM, a RAM, a magnetic disk, an optical disc, etc.

According to yet another aspect of the embodiments of this application, a storage medium is further provided. Optionally, in this embodiment, the above storage medium may be configured to execute program codes of the speech detection method.

Optionally, in this embodiment, the above storage medium may be provided on at least one of a plurality of network devices in the network shown in the above embodiments.

Optionally, in this embodiment, the storage medium is configured to store program codes for executing the following steps:
obtaining a multi-channel signal, where the multi-channel signal carries a current signal type; and
inputting the multi-channel signal into a joint model to obtain a speech detection result corresponding to the signal type, where the joint model includes a first model and a second model, the first model is configured to process the multi-channel signal into a single-channel signal, and the second model is configured to process the single-channel signal into the speech detection result.

Optionally, for a specific example in this embodiment, reference may be made to the examples described in the above embodiments, and details are not described herein again in this embodiment.

Optionally, in this embodiment, the above storage medium may include, but not limited to, various media that can store program codes, such as a USB flash disk, a ROM, a RAM, a mobile hard disk, a magnetic disk, or an optical disk.

According to yet another aspect of the embodiments of this application, a computer program product or a computer program is further provided, and the computer program product or the computer program includes computer instructions stored in a computer-readable storage medium; a processor of a computer device reads the computer instructions from the computer-readable storage medium, and the processor executes the computer instructions to cause the computer device to execute the method steps of speech detection in any one of the above embodiments.

The order of the above embodiments of this application is only for description, and does not represent the advantages and disadvantages of the embodiments.

If the integrated units in the above embodiments are implemented in the form of software functional units and sold or used as independent products, they may be stored in the above computer-readable storage medium. Based on such understanding, the technical solutions of this application, in essence, or the part that contributes to the related art, or all or part of the technical solutions may be embodied in the form of a software product. The computer software product is stored in the storage medium and includes several instructions to enable one or more computer devices (which may be a personal computer, a server, or a network device, etc.) to perform all or part of the steps of the method for speech detection in various embodiments of this application.

In the above embodiments of this application, the description of each embodiment has its own emphasis, and for parts not detailed in a certain embodiment, reference may be made to the related description of other embodiments.

In the several embodiments provided by this application, it should be understood that the disclosed client may be implemented in other ways. The apparatus embodiments described above are only schematic. For example, the division of units is only a logical function division, and there may be other division manners in actual implementation. For example, multiple units or components may be combined or integrated into another system, or some features may be ignored or not executed. In addition, the mutual coupling or direct coupling or communication connection as displayed or discussed may be indirect coupling or communication connection through some interfaces, units or modules, which may be in electrical or other forms.

The units described as separate parts may be physically separated or not, and the parts displayed as units may be physical units or not, that is, they may be located in one place or distributed to multiple network units. Some or all of the units may be selected according to actual needs to achieve the purpose of the solution provided in this embodiment.

In addition, the functional units in the embodiments of this application may be integrated in one processing unit, or each unit may exist physically alone, or two or more units may be integrated in one unit. The above integrated unit may be implemented in the form of hardware or software functional unit.

The above are only preferred implementation manners of this application. It should be pointed out that for persons of ordinary skill in the art, several improvements and modifications can be made without departing from the principles of this application, and these improvements and modifications should also be regarded as the protection scope of this application.

1. A speech detection method, comprising:
obtaining a multi-channel signal, wherein the multi-channel signal carries a current signal type; and
inputting the multi-channel signal into a joint model to obtain a speech detection result corresponding to the signal type, wherein the joint model comprises a first model and a second model, the first model is configured to process the multi-channel signal into a single-channel signal, and the second model is configured to process the single-channel signal into the speech detection result.

2. The method according to claim 1, wherein before the inputting the multi-channel signal into the joint model, the method further comprises:
obtaining a signal influence indicator according to the multi-channel signal, wherein the signal influence indicator is configured to affect a final output of the speech detection result; and
inputting the signal influence indicator and the multi-channel signal as input information into the joint model.

3. The method according to claim 1, wherein the inputting the multi-channel signal into the joint model to obtain the speech detection result corresponding to the signal type comprises:
inputting the multi-channel signal into the first model;
processing, by the first model, the multi-channel signal to obtain the single-channel signal;
inputting the single-channel signal into the second model; and
processing, by the second model, the single-channel signal to obtain the speech detection result.

4. The method according to claim 1, wherein the signal type comprises an audio, and the inputting the multi-channel signal into the joint model to obtain the speech detection result corresponding to the signal type comprises:
inputting the multi-channel signal into the joint model in response to that the signal type is the audio; and
outputting the speech detection result at intervals of a preset number of audio sampling points.

5. The method according to claim 1, wherein the signal type comprises a feature, and the inputting the multi-channel signal into the joint model to obtain the speech detection result corresponding to the signal type comprises:
inputting the multi-channel signal into the joint model and performing feature extraction and feature transformation on the multi-channel signal to obtain a frame frequency feature in response to that the signal type is the feature; and
outputting the speech detection result at intervals of a preset number of the frame frequency features.

6. The method according to claim 3, wherein after the inputting the multi-channel signal into the first model, the method further comprises:
determining, by means of the first model, spatial information when the multi-channel signal is input; and
re-obtaining the multi-channel signal in response to that it is determined that the spatial information changes within a preset time period.

7. The method according to claim 6, wherein the determining, by means of the first model, the spatial information when the multi-channel signal is input comprises:
determining, by means of the first model, an incidence orientation of the multi-channel signal; and
determining orientation information of a target object according to the incidence orientation, and taking the orientation information as the spatial information when the multi-channel signal is input.

8. (canceled)

9. An electronic device, comprising a processor, a communication interface, a memory and a communication bus, wherein the processor, the communication interface and the memory achieve mutual communication through the communication bus,
the memory is configured to store a computer program, and
the processor is configured to execute the following steps by running the computer program stored in the memory:
obtaining a multi-channel signal, wherein the multi-channel signal carries a current signal type; and
inputting the multi-channel signal into a joint model to obtain a speech detection result corresponding to the signal type, wherein the joint model comprises a first model and a second model, the first model is configured to process the multi-channel signal into a single-channel signal, and the second model is configured to process the single-channel signal into the speech detection result.

10. The electronic device according to claim 9, wherein the processor is configured to, before the inputting the multi-channel signal into the joint model, perform the following operations:
obtaining a signal influence indicator according to the multi-channel signal, wherein the signal influence indicator is configured to affect a final output of the speech detection result; and
inputting the signal influence indicator and the multi-channel signal as input information into the joint model.

11. The electronic device according to claim wherein the processor is configured to obtain the speech detection result corresponding to the signal type by performing the following operations:
inputting the multi-channel signal into the first model;
processing, by the first model, the multi-channel signal to obtain the single-channel signal;
inputting the single-channel signal into the second model; and
processing, by the second model, the single-channel signal to obtain the speech detection result.

12. The electronic device according to claim 9, wherein the signal type comprises an audio, and the processor is configured to obtain the speech detection result corresponding to the signal type by performing the following operations:
inputting the multi-channel signal into the joint model in response to that the signal type is the audio; and
outputting the speech detection result at intervals of a preset number of audio sampling points.

13. The electronic device according to claim 9, wherein the signal type comprises a feature, and the processor is configured to obtain the speech detection result corresponding to the signal type by performing the following operations:
inputting the multi-channel signal into the joint model and performing feature extraction and feature transformation on the multi-channel signal to obtain a frame frequency feature in response to that the signal type is the feature; and
outputting the speech detection result at intervals of a preset number of the frame frequency features.

14. The electronic device according to claim 11, wherein the processor is configured to, after the inputting the multi-channel signal into the first model, perform the following operations:
determining, by means of the first model, spatial information when the multi-channel signal is input; and
re-obtaining the multi-channel signal in response to that it is determined that the spatial information changes within a preset time period.

15. The electronic device according to claim 14, wherein the processor is configured to determine, by means of the first model, the spatial information when the multi-channel signal is input by performing the following operations:
determining, by means of the first model, an incidence orientation of the multi-channel signal; and
determining orientation information of a target object according to the incidence orientation, and taking the orientation information as the spatial information when the multi-channel signal is input.

16. The electronic device according to claim 11, wherein the electronic device further comprises a display, and the display is configured to display the speech detection result.

17. A non-transient computer-readable storage medium storing a computer program, wherein when the computer program is executed by a processor, a speech detection method. the method comprising:
obtaining a multi-channel signal, wherein the multi-channel signal carries a current signal type; and
inputting the multi-channel signal into a joint model to obtain a speech detection result corresponding to the signal type, wherein the joint model comprises a first model and a second model, the first model is configured to process the multi-channel signal into a single-channel signal, and the second model is configured to process the single-channel signal into the speech detection result.

18. (canceled)

19. (canceled)

20. The non-transient computer-readable storage medium according to claim 17, wherein before the inputting the multi-channel signal into the joint model, the method further comprises:
obtaining a signal influence indicator according to the multi-channel signal, wherein the signal influence indicator is configured to affect a final output of the speech detection result; and
inputting the signal influence indicator and the multi-channel signal as input information into the joint model.

21. The non-transient computer-readable storage medium according to claim 17, wherein the inputting the multi-channel signal into the joint model to obtain the speech detection result corresponding to the signal type comprises:
inputting the multi-channel signal into the first model;
processing, by the first model, the multi-channel signal to obtain the single-channel signal;
inputting the single-channel signal into the second model; and
processing, by the second model, the single-channel signal to obtain the speech detection result.

22. The non-transient computer-readable storage medium according to claim 17, wherein the signal type comprises an audio, and the inputting the multi-channel signal into the joint model to obtain the speech detection result corresponding to the signal type comprises:
inputting the multi-channel signal into the joint model in response to that the signal type is the audio; and
outputting the speech detection result at intervals of a preset number of audio sampling points.

23. The non-transient computer-readable storage medium according to claim 17, wherein the signal type comprises a feature, and the inputting the multi-channel signal into the joint model to obtain the speech detection result corresponding to the signal type comprises:
inputting the multi-channel signal into the joint model and performing feature extraction and feature transformation on the multi-channel signal to obtain a frame frequency feature in response to that the signal type is the feature; and
outputting the speech detection result at intervals of a preset number of the frame frequency features.
